(19) United States
(12) Patent Application Publication
(10) Pub. No.: US 2008/0250356 A1
(43) Pub. Date: Oct. 9, 2008

(54) METHOD AND SYSTEM FOR DYNAMIC, THREE-DIMENSIONAL NETWORK PERFORMANCE REPRESENTATION AND ANALYSIS

(75) Inventor: Michael Charles Johns, Austin, TX (US)

Correspondence Address: HULSEY IP INTELLECTUAL PROPERTY LAWYERS, P.C., 919 Congress Avenue, Suite 919, AUSTIN, TX, 78701, US

(73) Assignee: NetQoS, Inc.

(21) Appl. No.: 11/697,963

(22) Filed: Apr. 9, 2007

(51) Int. Cl. G06F 3/048

(52) U.S. Cl. 715/853

(57) ABSTRACT

Techniques for representing data network performance characteristics from many different sources shows in three-dimensions client stations representations, server station(s) representations, and various forms of data transmission representations a video animation subsystem. Operational characteristics representations associate with the client stations, server system, data transmission representations forming a dynamic, three-dimensional representation of the network for displaying operational characteristics of the client stations, server system(s), and data transmission. The dynamic, three-dimensional representation of the network interfaces with a network performance analysis system for further analyzing perceived operational characteristics with reference to a plurality of network performance metrics from the network performance analysis system.

### FIELD

The disclosed subject matter relates to data network monitoring systems and processes such as may find use in network performance reporting and analysis. More particularly, this disclosure relates to a novel and improved method and system for dynamically generating and presenting three-dimensional, time-based video images representing network performance and quality of service across data networks of a wide variety of sizes located in myriad geographic locations worldwide.

### DESCRIPTION OF THE RELATED ART

Network diagnostics provide requisite visibility for managing network performance to avoid unexpected and costly consequences of failing to have key diagnostic information. Visibility is so important that it stands alone as a sentence in any document, text, or presentation on network performance. Imagine attempting to manage network performance across an enterprise without knowing who is using the network, when they are using the network, and without knowing if the routers and switches are running at their limits, or are failing intermittently.

The main areas of visibility required to effectively manage a network for performance may be divided into three major categories, including end-to-end response time, traffic flow data, and device performance information. Presently, a need exists to improve visibility in these three categories to provide necessary and sufficient visibility into or perception of the performance end users are experiencing as well as the performance of an IT organization's network. There is also the need to provide relevant diagnostic information to identify, manage, verify, and solve root cause issues within a network. While network availability may be visualized as red or green, for example, performance understanding may require many shades of colors in between.

Once a performance problem is identified, a next hurdle to overcome is lack of visibility into the root cause of the problem or even where the problem occurred. The causer may be within an application itself, a server that's hosting an application or the network. Often up to twenty highly paid IT professionals may require hours or even days to diagnose performance problems. Then, there is the time and expense of repairing the identified problems.

To determine if an application performance problem is caused by the network, engineers and managers need to know three things about the performance of critical links: (a) latency-how much time does it take for traffic to pass down the link?; (b) utilization and protocol information—what is using network links, when, and for how long?; and (c) packet drop-how much traffic is lost or delayed because of overflows in the queues?

Also, CPU use should be monitored and trended to ensure it remains within accepted bounds for optimal performance while providing enough room to handle atypical events that may occur within the network (such as an outbreak of a virus, or a major change in routing or switching tables). Memory utilization should also be monitored and trended to ensure that enough memory is available in free memory pools and available for allocation to key processes. Over-utilization of interface and backplane resources also can lead to packet drop, route flapping, reduction of data throughput, and device instability. For this reason, traffic utilization in both directions should be monitored separately so that congestion in either direction may be detected and corrected. Another significant contributor to network performance issues concerns the existence of errors in networking equipment due to hardware/software malfunction or configuration errors.

Presently, the methods and systems for dynamically viewing or otherwise sensing network performance are limited. Generally, such systems, while perhaps being capable of performing dynamic reporting and visualization, are two-dimensional, providing graphs and charts of network performance, and may fail to portray a clear view for all concerned with network performance analysis. Even for such systems and methods that provide understandable graphical representations of network performance, there is still much room for improvement and invention over presently known systems and methods.

Also, because of the large amount of network performance data that may be generated across a large enterprise network, it is simply not possible, using known systems to extract all meaningful data that network performance system may provide.

Accordingly, there is the need for a system that improvises the ability of a network provider to focus on the performance of key applications running over the network and identifying where there is opportunity for improvement.

There is a need for an improved visualization tool that allows an IT organization to make more informed infrastructure investments and resolve problems that impact the business.

There is a further need for a network performance monitoring system and method of operation that allows for global visibility for even the largest enterprises into all key metrics necessary to take a performance first approach to network management.

### SUMMARY

Techniques for dynamic, three-dimensional network performance and quality of service presentation and analysis are here provided that overcome or substantially eliminate limitations associated with prior methods and systems.

According to one aspect of the disclosed subject matter, a method and system are provided for representing network performance characteristics from a plurality of sources by providing in three-dimensions a plurality of client stations representations associated with a predetermined data and communications network using a video animation subsystem. The disclosed subject matter provides in three-dimensions at least one server station representations associated with a predetermined data and communications network using the video animation subsystem and a plurality of forms of data transmission representations for representing data transmission and communications between the plurality of client stations and the at least one server system using the video animation subsystem. The present disclosure further forms operational characteristics representations associated with the plurality of client stations representations, the at least one server system representation, and the plurality of forms of data transmission representations using the video animation subsystem, thereby forming a dynamic, three-dimensional representation of the network comprising the operational characteristics, the plurality of client stations, the at least one server system, the plurality of forms of data transmission. The dynamic, three-dimensional representation of the network interfaces with a network performance analysis system for further analyzing perceived operational characteristics representations with reference to a plurality of network performance metrics associated with the network performance analysis system.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages be included within this description, be within the scope of the accompanying claims.

### BRIEF DESCRIPTIONS OF THE DRAWINGS

The features, nature, and advantages of the disclosed subject matter may become more apparent from the detailed description set forth below when taken in conjunction with the drawings in which like reference characters identify correspondingly throughout and wherein:

FIG. 1 is a simplified scalable network such as for which the teachings of the disclosed subject matter have application;

FIG. 2 illustrates one embodiment of a passive network performance monitoring system for which the present disclosure has application;

FIG. 3 provides an alternative embodiment of a network performance monitoring system for which the present disclosure also has application;

FIG. 4 discloses various aspects of deploying a passive network performance monitoring system for which the disclosed subject matter provides benefit;

FIG. 5 presents various aspects of server-side monitoring for which the present disclosure provides performance reporting functions;

FIG. 6 provides a graphical display of performance information available from a network performance monitoring system with which the presently disclosed subject matter may associate;

FIG. 7 shows initial measurements occurring within the underlying passive network performance monitoring system to which the present subject matter relates;

FIG. 8 illustrates, in summary form, the functions reported by the present dynamic, three-dimensional network performance monitoring system of the present disclosure;

FIG. 9 depicts a plot of initial server response time with which the presently disclosed subject matter may associate;

FIGS. 10, 11 and 12 depict collector and master processes, and coordinated collector-master processes which the present disclosure makes more immediately perceivable; and

FIGS. 13 through 30 show novel views of passive network performance monitoring occurring through the use of the presently disclosed subject matter.

### DETAILED DESCRIPTION OF THE SPECIFIC EMBODIMENTS

The disclosed subject matter provides data center appliance that passively monitors end-to-end performance for all users accessing local server farm services. The present disclosure provides, in particular, a dynamic three-dimensional, visual representation of end-user response time and identifies network, server, and application components for measuring user throughputs, loss rates, byte rates, session refusals, and other metrics. In certain embodiments, the present disclosure dynamically provides visual and auditory representations of network performance metrics, which metrics representations are highly user controllable. As a result, the present disclosure allows a user to automatically detect and investigate performance issues in real time. Using the dynamic three dimensional representation of the present disclosure, both availability and performance SLAs to document consistent levels of service quality for internal and external use.

The disclosed subject matter technique interprets network performance data from various sources and renders the results as an interactive, three-dimensional animation with associated sound. The output of this method is intuitive to understand, and offers an alternative method of viewing network performance data that presents the big picture and draws attention to where it is needed with reduced attentional and cognitive demands on the user.

This work is most likely differentiated from prior work in its use of domain-specific information to enhance the visualization's interpretability. It directly visualizes what is being measured and does so within a context that users can easily translate back to reality.

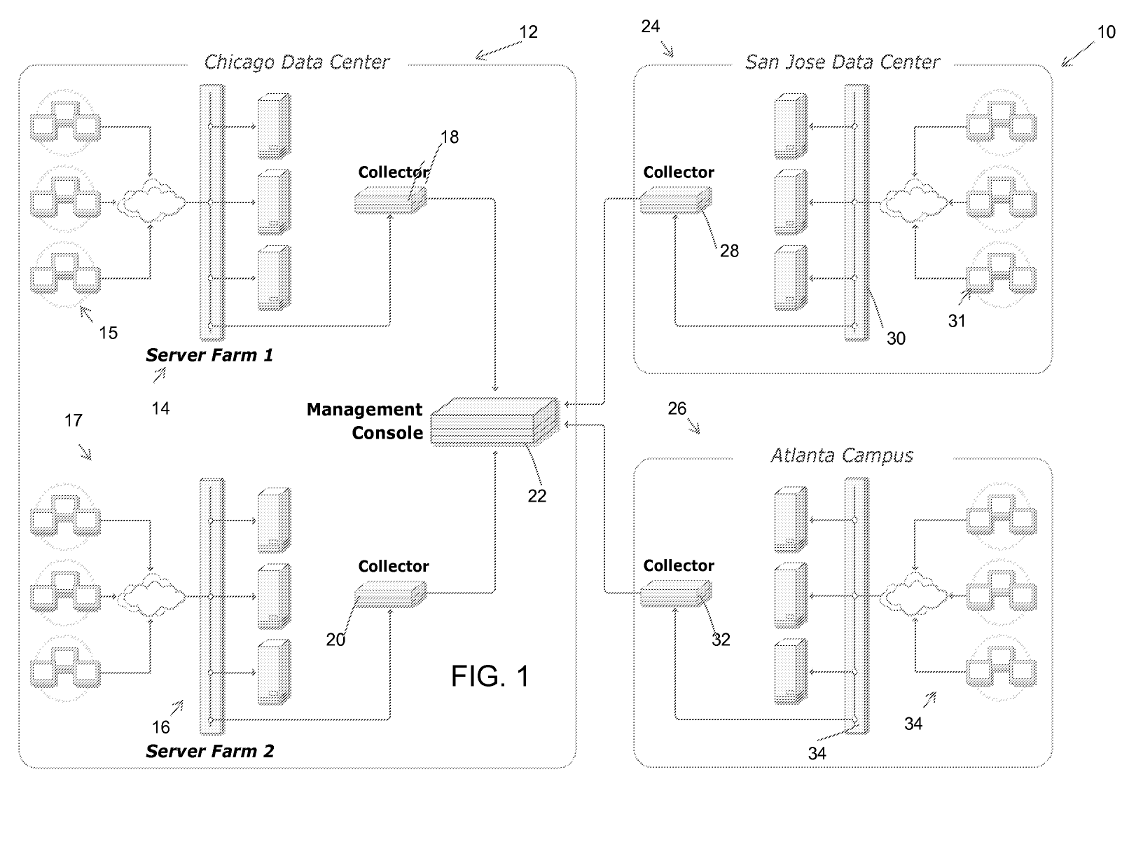

FIG. 1 is a simplified scalable network 10 such as for which the teachings of the disclosed subject matter have application. Network diagram 10 includes a Chicago data center 12, which includes server farm 1 14 which serves client stations 15 and server farm 2 16 serving client stations 17. Server farm 1 14 provides input to collector 18, while server farm 2 provides input to collector 20, both of which provide input to management console 22. Management console 22 also receives input from San Jose data center 24 and Atlanta campus 26. At San Jose data center 24, collector 28 receives input from server farm 30, which serves client stations 31. Likewise, at Atlanta campus 26, collector 32 receives input from server farm 32 serving client stations 34. This typical configuration may be monitored by a network performance monitoring system, such as the system disclosed in U.S. patent application Ser. No. 10/138,785, entitled “Server-Site Response Time Computation for Arbitrary Applications” and U.S. patent application Ser. No. 10/962,331, entitled “Dynamic Incident Tracking and Investigation in Network Monitors,” which are commonly assigned to the assignee of this disclosure and are here incorporated by reference.

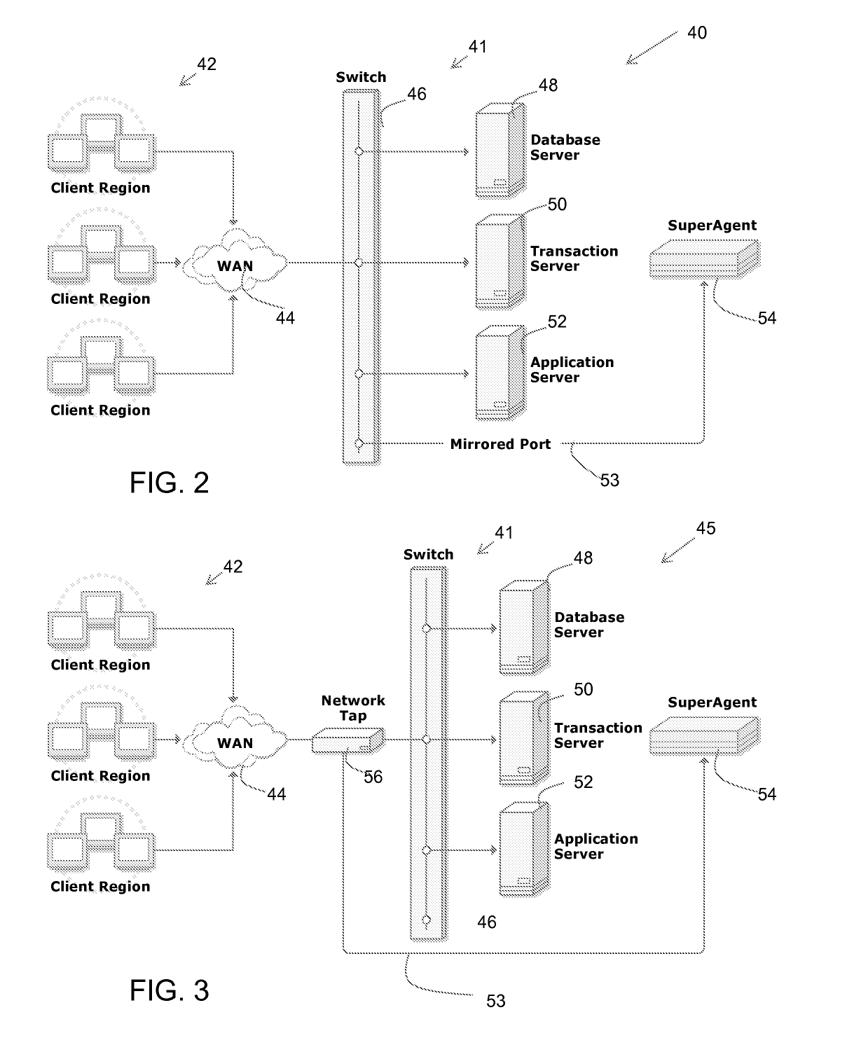

FIG. 2 illustrates one embodiment of a passive network performance monitoring system for which the present disclosure has application. In FIG. 2, network 40 includes server farm 41, which serves client stations 42 via WAN 44. Server farm 41 provides, using switch 46, inputs to database server 48, transaction server 50, and application server 52. Through a mirrored port 53, switch 46 provides information to network performance monitoring system 54. Network performance monitoring system 54, with which the presently disclosed subject matter associates, may be such as sold by NetQoS, Inc. of Austin, Tex. under the brand “SuperAgent.”

FIG. 3 provides an alternative embodiment of a network performance monitoring system for which the present disclosure also has application. In FIG. 3, network 45 also includes server farm 41, which serves client stations 42 via WAN 44. Server farm 41 provides, using switch 46, inputs to database server 48, transaction server 50, and application server 52. In network 45, network tap 56 sits between WAN 44 and switch 46 to provide input to network performance monitoring system 54.

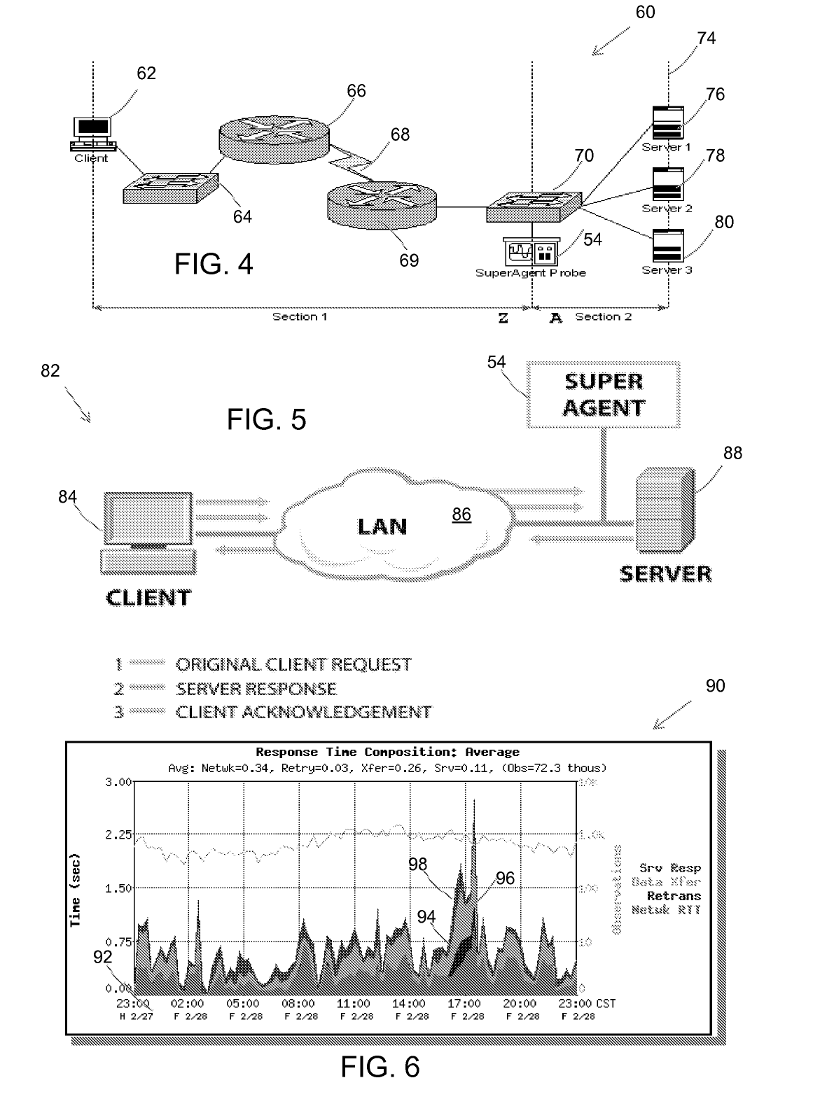

FIG. 4 discloses various aspects of deploying a passive network performance monitoring system for which the disclosed subject matter provides benefit. The deployment example of FIG. 4 shows client station 62 which through a first network Section 1, which may include network components 64, 66, and 69, as well as communication path 68. These network components, for example, have various component delays in reaching server farm 70. Network performance monitoring system 54 may determine these delays and assess network performance associated with them. In addition network performance monitoring system 54 also assess performance of a section 2 portion of the network relating to server farm 74, as server sites 76, 78, and 80 respond to received communications. Section 1 provides timing packet pairs, and provides information on network (WAN) latency. Network performance system 54 component times that consist of packets traveling across Section 1 are directly affected by the condition of the network (e.g., bandwidth, congestion, circuit condition, etc.). Section shows a probe for network performance monitoring system 54 residing locally on the same Ethernet switch as the servers 76, 78, and 80. Packets traveling across section 2 are directly affected by the condition of the server, or its ability to complete TCP connection or application requests in a timely manner. The three-dimensional network performance visualization system of the present disclosure may operate in an environment such as that of FIG. 4 to aid in visualizing and isolating the various performance concerns that may arise.

FIG. 5 presents various aspects of server-side monitoring for which the present disclosure provides performance reporting functions. In simple terms, network 82 shows client station 84 communicating with LAN 86, which interfaces server 88. Network performance monitoring system 54 may tap into the communications between LAN 86 and server 88 to calculate the network component of round-trip response time. This determination occurs by tracking the time differential between the server's response and corresponding acknowledgement from the client. These measurements are continuously updated during client-server interactions to reflect changing network conditions. Network performance monitoring system 54 includes algorithms and processes to compensate for the fact that TCP does not need acknowledgement for every packet, nor does it need to respond immediately.

FIG. 6 provides a graphical display 90 of performance information available at a basic level of the presently disclosed subject matter. Within graphical display 90 are shown network round trip measurement 92, data transfer delay measurement 94, retransmission delay measurement 96, and server delay measurement 98. These measurements provide quantitative information that the presently disclosed three-dimensional dynamic network performance video display system makes more clearly perceivable by a user.

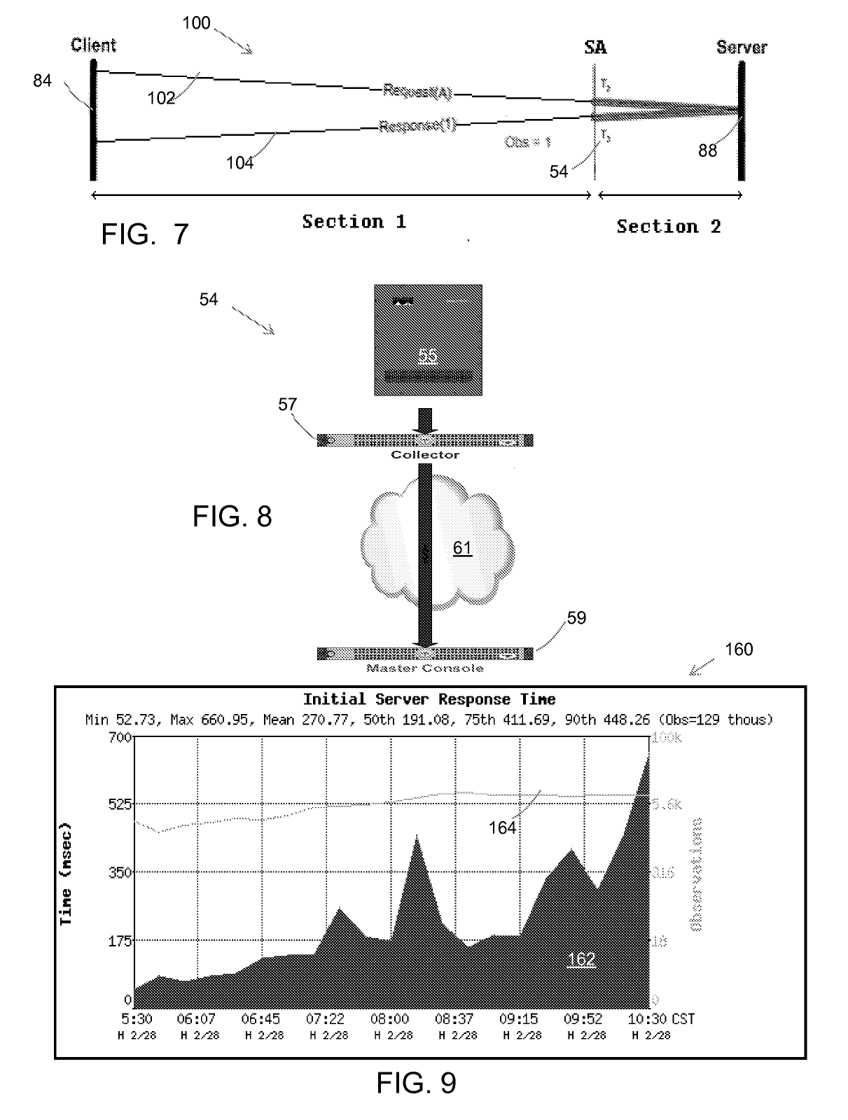

FIG. 7 shows initial measurements 100 occurring within the underlying passive network performance monitoring system 54 to which the present subject matter relates. That is, from client side 84, a request 102 travels through section 1, through the network performance monitoring system 54 network tap and on to server 88. Server 88 provides a response, which network performance monitoring system 54 also senses as it continues on to client 84. The results of measurements from network performance monitoring system 54 includes a Server Response Time (SRT), which measures the server “think time”. SRT is calculated by measuring the amount of time it takes for a server to transmit an initial packet in response to a client request packet. Network performance monitoring system 54 receives packets from a NIC packet driver.

FIG. 8 illustrates, in summary form, the basic components of the network performance monitoring system 54 with which the presently disclosed method and system support through a novel dynamic, three-dimensional video presentation. Network performance monitoring system 54 includes a processing engine 55, for watching packets traveling over a network to collect metrics, send alarms when thresholds are violated, and save data relating to network performance. A collector messenger service 57 allows a master console 59 to administer collector. Collector management service 57 listens for data requests from master console 59. And a master batch 61 that provides a process of pulling data files to the master console 59.

The dynamic, three-dimensional network performance monitoring display of the present disclosure provides a novel and valuable means of expressing the numerous functions that network performance monitoring system 54 performs. These processes include, but are not limited to a data pump service, a collector management service, a messenger service, a master batch service, a collector batch service, an inspector service, an inspector agent service, and a MySQL service.

The network performance monitoring service connects back to the master database and pulls configuration to perform the actual data collection by listening in on the monitor NIC(s). It creates data files that are transferred by the collector management service and on the other end, the master batch service.

The collector management service listens on port 8080 for requests for moving super agent data files to the collector. The messenger service listens for commands for controlling the collector (reboot, restart, reload, status, etc.) on port 1000. The inspector agent service can be stopped/restarted at anytime. Whenever an investigation occurs, it goes through the inspector agent. Any failures that occur in the inspector service are logged into the Windows event log under application. The Windows event log is adjusted to become a circular log to avoid disk space failures related to log growth. The master batch service pulls datafiles and places them in the datafiles directory and polls collectors via port 8080. The data pump service loads data into database, constructs cache files to speed up common reports, builds summary database tables, performs backup database if scheduled backup is enabled, deletes old data, and cleans up old images.

The inspector service conducts scheduled investigations. Opens/Closes and tracks incidents. When appropriate, the service will attempt to send email via mailpage.exe. The inspector service performs the availability checking, which may involve pinging servers or connecting to application ports if there is no passive evidence that the application is working. Also, the inspector service computes nightly baselines and alarm thresholds. Network performance monitoring system 54 also provides event detection, basic event reduction, and active investigations based on type of event detected. For a server it is possible to launch an SNMP poll and/or ping response times. For a client region it is possible to launch a trace route. For an application it is possible to launch an application port. For ping investigation it is possible to manually ping a device with a range of packet sizes. All of the above services are described in product literature associated with the NetQoS SuperAgent® product line and are here incorporated by reference.

FIG. 9 depicts an initial server response time plot 160 to demonstrate how network performance monitoring system 54 provides valuable information regarding network performance, which information is made much more visible and understandable using the presently disclosed subject matter. Initial server response time plot 160, plot 162 shows a growing server response time, ranging from approximately 80 msecs on February 28 at 5:30 a.m. to over approximately 600 msec at 10:30 a.m. that same day, while traffic, as shown on line 164 grows only slightly, averaging approximately 5,600 messages or observations. While this information is visually useful, the presently disclosed subject matter now takes this information and substantially improves a user's ability to understand and perceive its import.

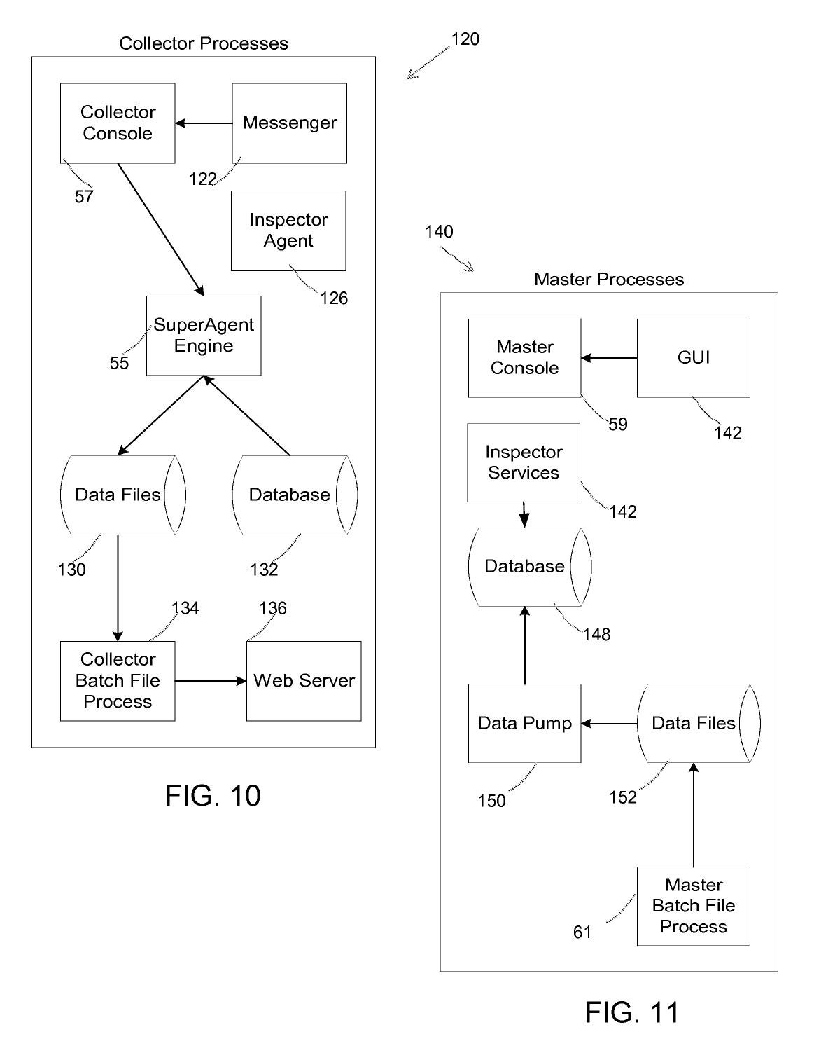

FIGS. 10, 11 and 12 depict collector and master processes, and coordinated collector-master processes which the present disclosure makes more immediately perceivable. Referring to FIGS. 8 and 10, there appears the collector processs 120 performed by network performance monitoring system 120, beginning with messenger functions 122. Messenger functions 122 provide input to collector console 57, as inspector agent 126 resides with collector processes and is ready for responding to inspection commands. Collector console 57 provides input to performance monitoring engine 55, which receives data from database 132 and responds by generating data for data files 130. Data files 130 are, in response, provided to collector batch file process 134, which provides input to web server 136.

Thus, as FIG. 10 shows, network performance monitoring engine 55 collects packet header information, stores metrics data and sends alarms. Collector console 57 listens for data requests from master console 59, while messenger service allows master console to administer collector 57. Master batch process 61 enables the process of pulling data files to master console 59. Thus, the collector processes outlined in FIG. 10 include watching packets to collect metrics, sending alarms when thresholds are violated, saves data, and provides a list of data files on the collector. The collector processes also involve transferring data file to master and deleting data files from the slave. Inspector agent 126 provides for event detection, and basic event reduction. Messenger 122 listens for commands from master console 59.

FIG. 11 provides a flow diagram 140 for the master processes of network performance monitoring system 54 with which the present disclosure associates. Beginning at graphical user interface (GUI) 142, which here includes the disclosed subject matter, inputs go to master console 59. Inspector services 142 provide data to database 148. Inspector Services 142 conducts scheduled investigations, opens/closes and tracks incidents, and performs availability checking. These processes may involve pinging servers or connecting to application ports if there is no passive evidence that the application is working. All pings and TCP connection attempts are done through inspector agent 126 (FIG. 10) and not directly by inspector service 142. Database 148 also receives input from Data Pump 150. Data pump 150 populates database 148 and manages reporting back end. Data files 152 go to data pump 150 from master batch file process 61.

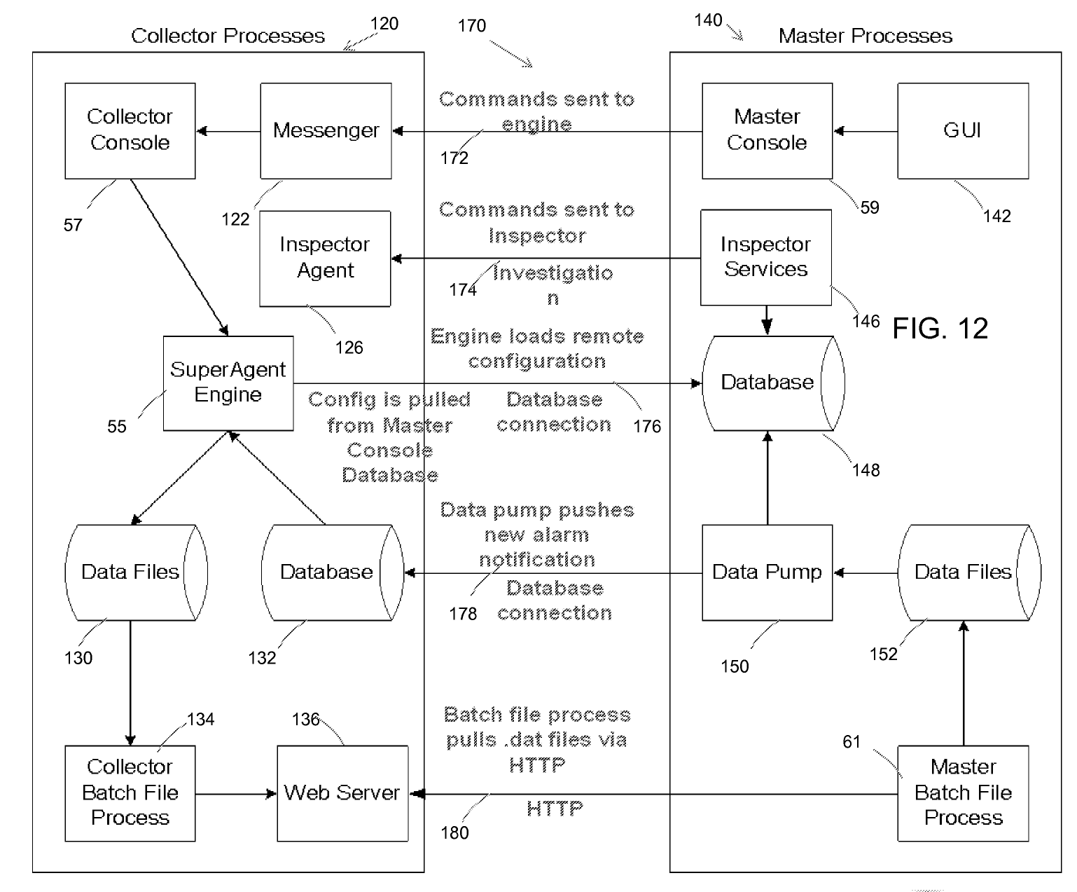

Having introduced the collector processes 120 and master processes 140 of network performance monitoring system 54, the interaction between these processes is presented. FIG. 12 outlines the collector communications 170 occurring between collector processes 120 and master processes 140. Collector communications 170 include master console 59 sending commands 172 to messenger. Inspector services 146 also send commands 174 to inspector agent 126 for investigation functions, as stated above. Network performance monitoring engine 55 loads 176 remote configuration to database connection 148, while configuration information is pulled from master console 59 database. Data pump 150 pushes 178 a new alarm notification database connection to database 132. Also master batch file process 61 .dat files via HTTP to web server 136.

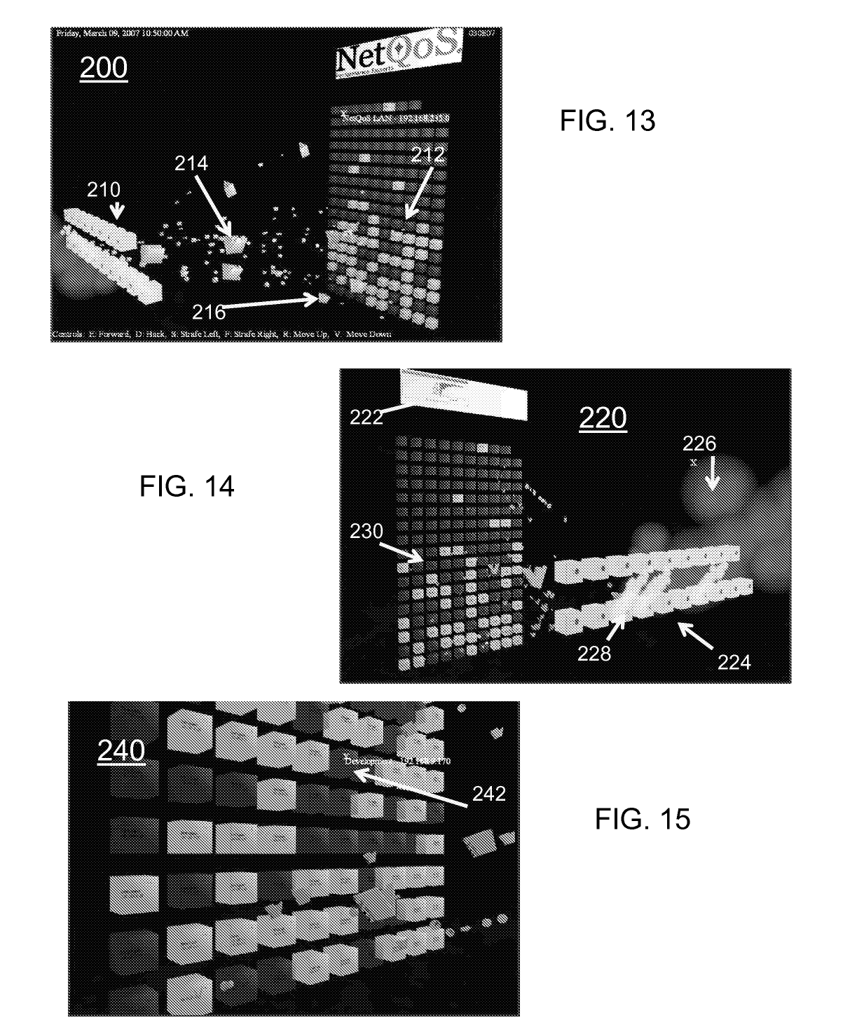

FIGS. 13 through 26 show novel views of passive network performance monitoring occurring through the use of the presently disclosed subject matter. The present disclosure makes advantageous use of a three-dimensional animation software development kit, such as the Microsoft® XNA framework. However, other similar programs and programming environments with similar functionality may provide such features and functions as may be associated with the presently disclosed subject matter.

The XNA Framework is based on the .NET Framework 2.0. It includes an extensive set of class libraries, specific to game development, to promote maximum code reuse across target platforms. The framework runs on a version of the Common Language Runtime that is optimized for gaming to provide a managed execution environment. The runtime is available for Windows XP, Windows Vista and Xbox 360. Since XNA games are written for the runtime, they can run on any platform that supports the XNA Framework with minimal or no modification. Games that run on the framework may be written in C# using the XNA Game Studio Express IDE.

The XNA Framework encapsulates low-level technological details involved in coding a game, making sure that the framework itself takes care of the difference between platforms when games are ported from one compatible platform to another, and thereby allowing game developers to focus more on the content and gaming experience. The XNA Framework integrates with a number of tools, such as XACT, to aid in content creation. These tools can help author the visuals or sounds in the game, and model characters with life-like dynamism.

The XNA Framework provides support for 3D game creation, and allows use of the Xbox 360 controllers and vibrations. The Xbox Live Marketplace allows programmers to upgrade their version of XNA Game Studio Express and let them play games on their Xbox 360.

XNA also provides a set of game asset pipeline management tools, which help by defining, maintaining, debugging, and optimizing the game asset pipeline of individual game development efforts. A game asset pipeline describes the process by which game content, such as textures and 3D models, are modified to a form suitable for use by the gaming engine. XNA Build helps identify the pipeline dependencies, and also provides API access to enable further processing of the dependency data. The dependency data can be analyzed to help reduce the size of a game by finding content that is not actually used.

Now, with reference to FIGS. 13 through 30, the following provides illumination as to the various features of the present disclosure. The presently disclosed dynamic, three-dimensional network performance monitoring display system significantly reduces the cognitive burden to increase the ability to use network performance monitoring system 54. In addition, by employing a user's sense of vision and hearing, subtle cues associated with network performance will be noticed, oftentimes more readily.

Using the present system, numerous metrics can be presented simultaneously, increasing the amount of information conveyed and allowing users to make visual correlations to identify significant events. Auditory cues inform users whose attention is primarily elsewhere. While graphs require full attention, sounds can be readily ignored until their pattern is broken. Visual and auditory cues presented in this manner leverage the pattern-detecting abilities of the human brain: rather than using machine pattern detection to send single alerts, a continuous stream of background noise affected in subtle ways by network performance data invokes the user's natural pattern-detection abilities. Since this application provides a great deal of information at a glance, it can be used as an entry point to a more detailed analysis environment within the context of interest. For example, a means could be provided by which one could launch a web application to view various information about a server's performance by clicking on that server from within the visualization. In general, this method would be useful in a number of domains. However, each particular implementation is inherently domain-specific.

FIG. 13, therefore, provides an overview diagram 200 of the presently disclosed dynamic, three-dimensional network performance monitor visualization system. Overview diagram may be represented on a computer screen tasked with monitoring a network using network performance monitoring system 54, for example. Spatially, therefore, overview diagram 200 shows servers 210 communicating with client stations 210. Communication files and data between servers 210 and client stations 212 are shown as various file images 214 and 216.

The speed of the request varies according to Network Round Trip Time, and its length or size, depending on a particular implementation, varies according to the measured volume of data. As used herein, the term “request” within a visualization includes a representation of the traffic for a particular application from a particular client region to a particular server summarized over a period of time (e.g, five (5) minutes, such as in the SuperAgent® network performance monitoring system 54. Upon reaching the server, the request stops for a period of time related to the server response time as measured by SuperAgent, and is then sent back to the client.

FIG. 14 shows a view 220 of the dynamic, three-dimensional network performance monitor visualization system interfacing with a graphical user interface of network performance monitoring system 54, as described in detail above. In FIG. 14 appears display 222 showing a diagram that network performance monitoring system 54 may provide. View 220 provides such views 222 as a user may select. FIG. 14 also shows servers 224 which exhibit various states of operation. For example, using smoke display 226, view 220 may show that one or more servers are operating a slow rate. If a server operates at an even slower rate, then, as fire display 228 portrays, one or more servers may appear as burning. There may be other ways of showing server performance, all within the scope of the disclosed subject matter.

FIG. 14 view 220 shows users can “fly” through the animation using the keyboard and mouse to control the position and orientation of the camera, and pause the animation to inspect individual entities. This is the beginning of enabling troubleshooting once attention has been drawn to a particular entity. Requests emit sounds whose pitch varies according to their speed. This both enhances the presentation and allows users to notice subtle changes in network performance without looking at the screen.

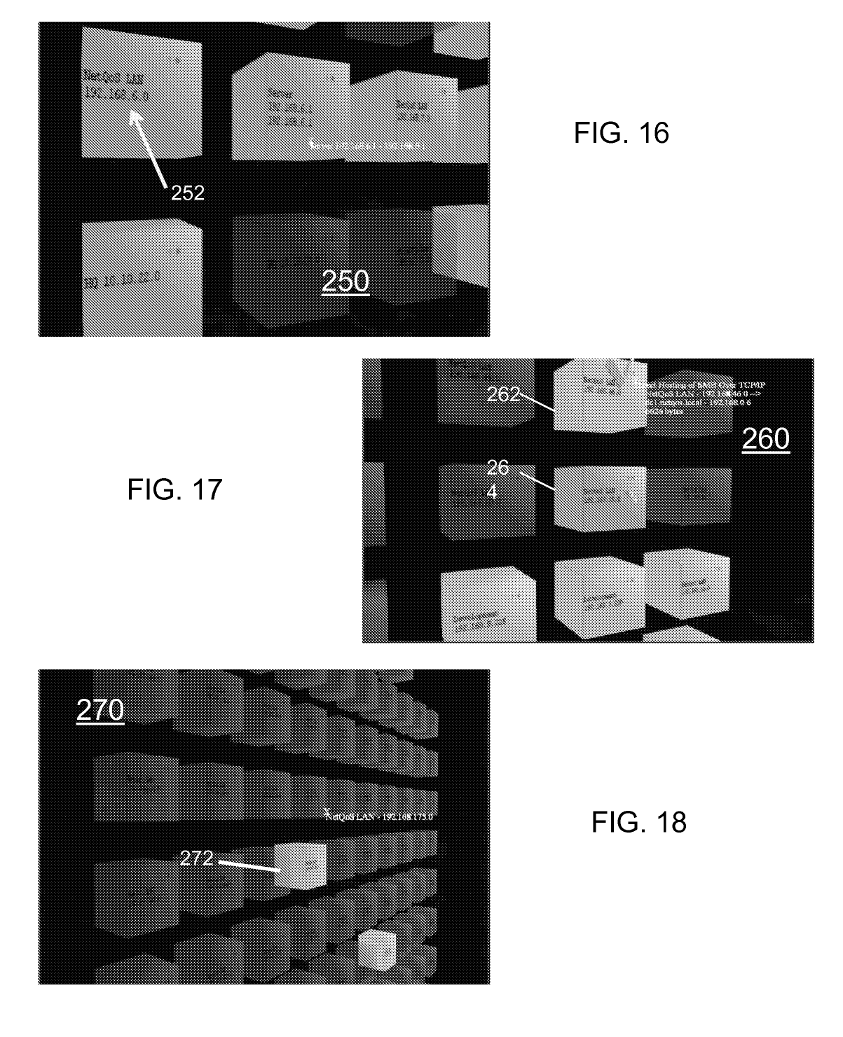

FIGS. 15 and 16 provides a three-dimensional dynamic view of client stations as seen with the present disclosure. View 240 shows aspects of the present disclosure for directing the dynamic, three-dimensional performance display system to isolate certain client stations 242, show only those client stations 242 that may be operating, or provide textual and other information regarding particular client stations within a network. FIG. 16, in particular, presents view 250 which demonstrates a view of selected client stations 252 a particular set of client stations as allowed by the navigation features of the present disclosure.

FIG. 17 highlights in view 260 whether particular client stations are operating satisfactorily. View 260 shows, for example, client station 262 as a green color to indicate satisfactory operation. On the other hand, client station 264 has a red color showing less than satisfactory operation. There are other colorations and visualizations that the present disclosure may provide for client stations, such as client stations 262 and 264, including textual information stating the IP address for the client station, as well as other relevant information. as seen through the present visualization system to indicate a quality of service problem occurring at the particular client station.

FIG. 18 shows view 270 to demonstrate the ability of the present disclosure to isolate or filter a particular client station 272 for further analysis.

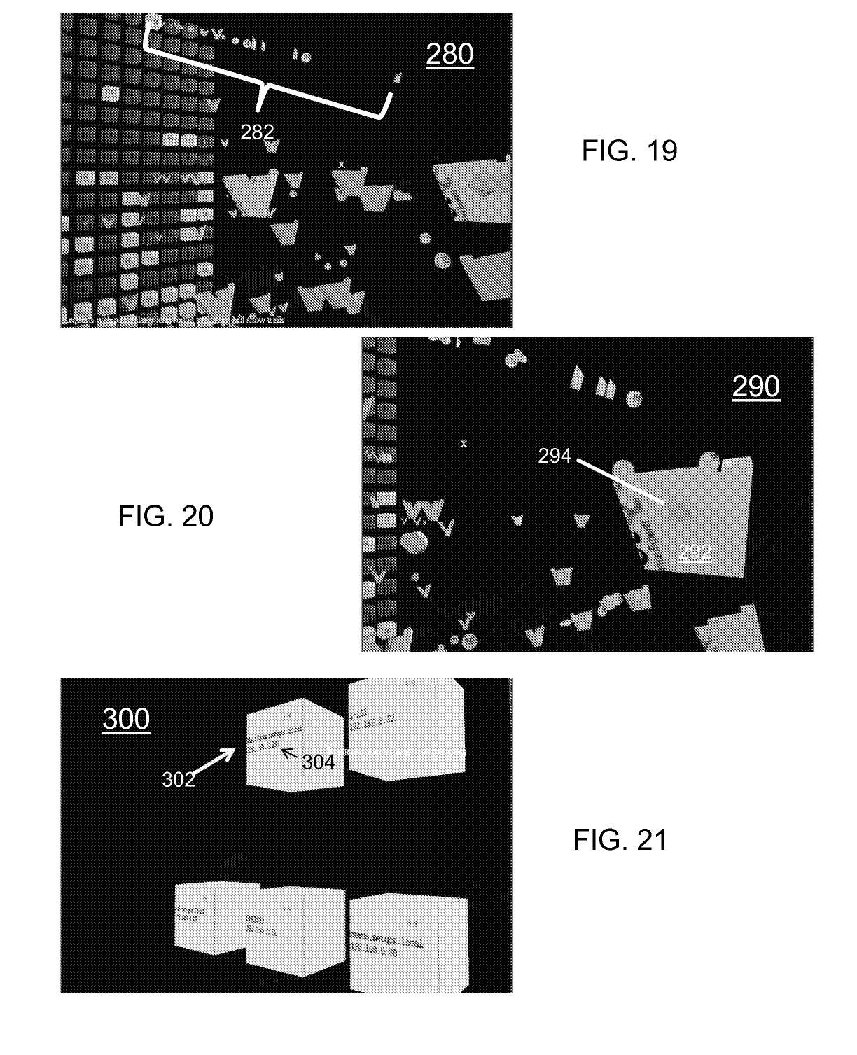

FIG. 19 shows in view 280 how the presently disclosed system may depict slow traffic having a trail 282. Such a trail 282 may suggest to a user a need to examine the cause abnormally slow traffic flow.

FIG. 20 presents in view 290 a feature of the present system for showing variations in file size through variations in visual presentation of the file. Thus, file 292, containing much data, appears large. On the other hand, file 294, containing comparatively less data, appears smaller. Note, also the feature of the present disclosure to prevent the larger file 292 from hiding smaller file 294 by, for example, showing the smaller file 294 as a different color behind larger file 292.

FIG. 21 depicts in view 300 the ability the present system to isolate or filter a particular set of servers 302 for further analysis. Information 304 about a client region or server is written directly onto its texture map. This allows users to easily relate animated entities with their real-life counterparts.

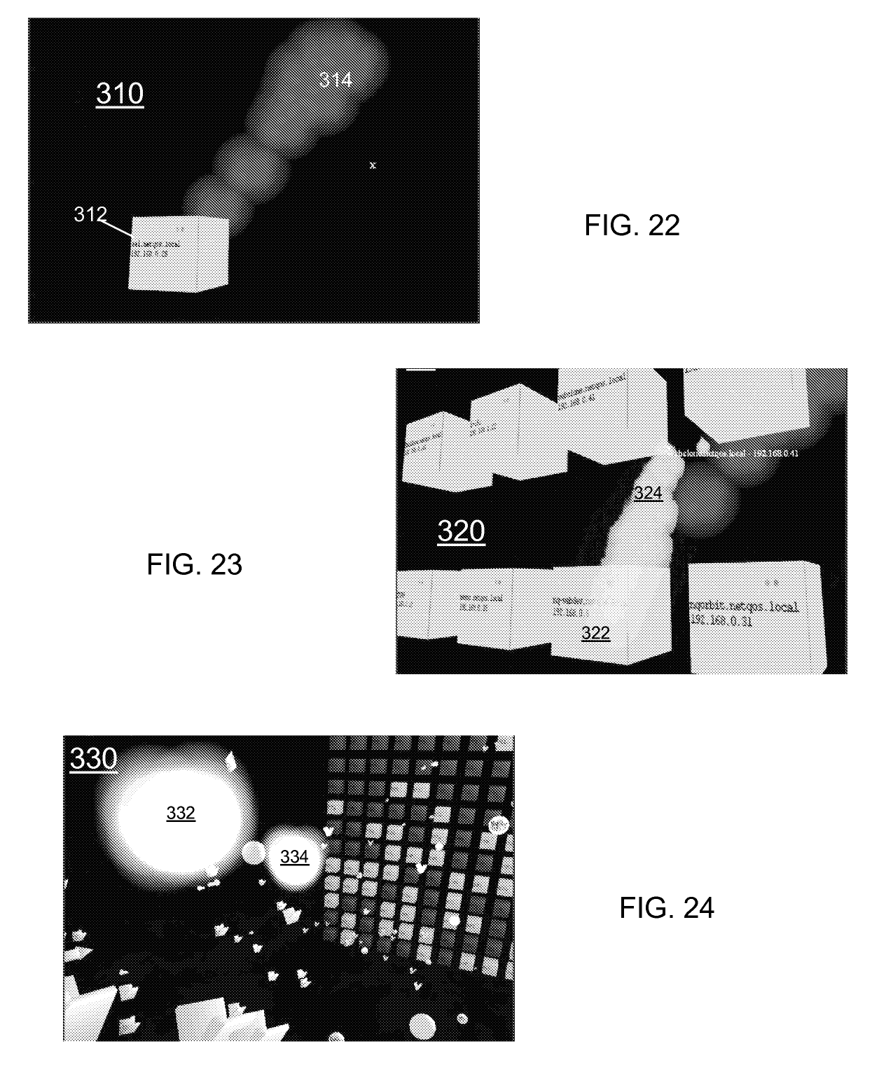

FIG. 22 shows in view 310 an aspect of the present disclosure wherein for a slow responding server 312 smoke 314. FIG. 23 shows view 320, which goes even further for yet poorer performing server 322 a flame 324 to indicate performance falling well below satisfactory performance.

FIG. 24 presents in view 330 how the disclosed system depicts retransmitted traffic. Thus, for traffic failing to reach either a client station or server station, explosion representations 332 and 334, for example, show the need for and act of retransmission.

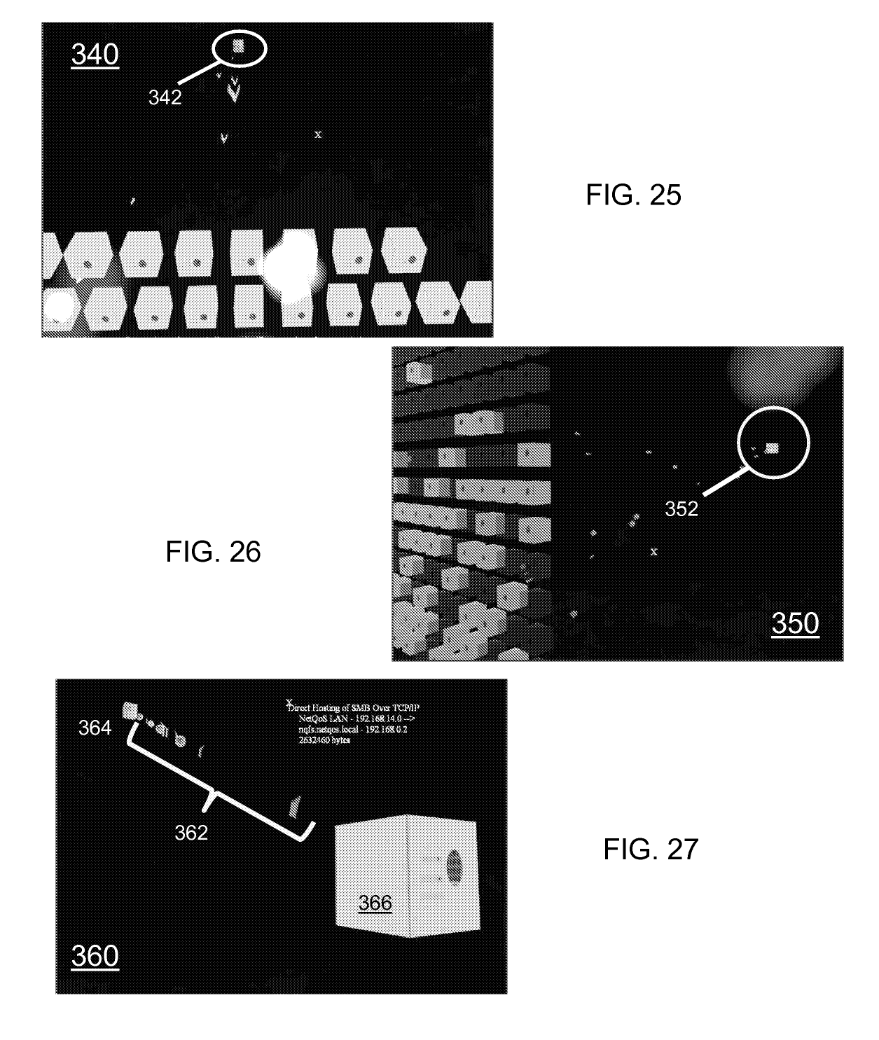

FIG. 25 provides view 340 to illustrate the ability of the presently disclosed system to isolate or filter a single client station 342 for further analysis and troubleshooting. Thus, while other client stations are operating, the three-dimensional display system of the present disclosure allows the ability to view specifically how a client station such as client station 342 may be performing. FIG. 26, likewise, shows view 350 that demonstrates how the presently disclosed system enables isolation of a single server system 352 for further analysis. Still further, FIG. 27 demonstrates in view 360 how the present system permits isolation of a single message or file transfer to isolate problems associated with such message or file. In FIG. 27, message trail 362 shows communication between client station 364 and server 366. This ability to specifically isolate individual message streams provides potentially valuable information to a network administrator.

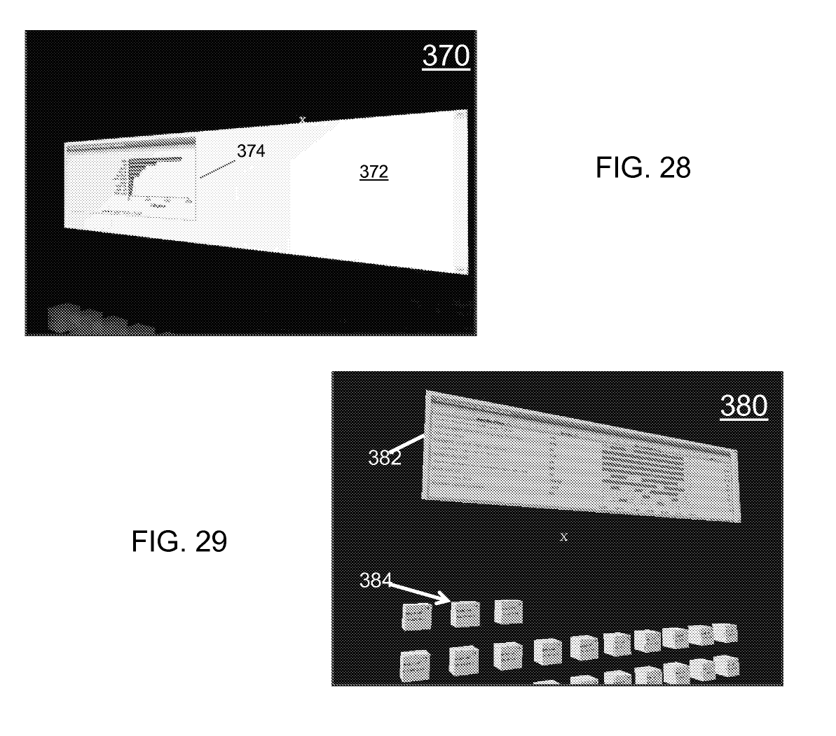

FIGS. 28 and 29 show in views 370 and 380, respectively, how the presently disclosed system provides a direct interface with network performance monitoring system 54 for integrated use in network performance analysis and reporting, as well as all of the network performance monitoring functions detailed above. Thus, view 372 of FIG. 28 shows one or more bar graphs 374 that may be viewed in network performance monitoring system 54. Also, view 382 shows reports and other performance graphs from network performance monitoring system 54. The result is a greater return in the amount of information and a synergistic cooperation between network performance monitoring system 54 and the presently disclosed dynamic, three-dimensional display system.

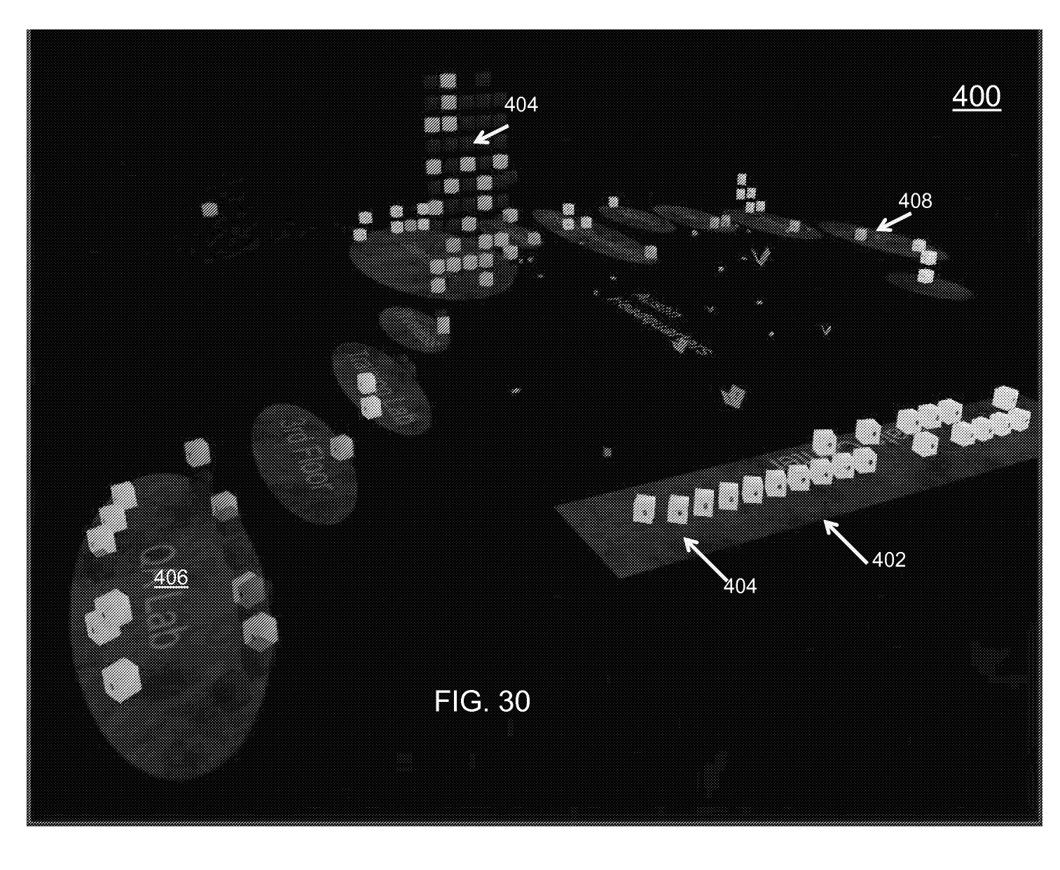

FIG. 30 shows yet a further advantageous feature of the presently disclosed subject matter in view 400. View 400 exhibits the ability of the dynamic, three-dimensional network performance display system to graphically relocate both servers 402 and client stations 404. Moreover, servers 402 and client stations 404 may be related in display 400 as user may desire. Thus, view 400 may demonstrate geographically different locations for the various servers 402 and client stations 404. Also, view 400 may show various different functions or assignments that such equipment may have. A user may “drop and drag” one or more servers 402 or client stations 404 to any desired location in view 400. Also, view 400 provides the ability to a label 404 or 408 to indicate the assignment, geographical location, or other basis separation that a user may select.

In summary, the disclosed subject matter provides a method and system for representing network performance characteristics from a plurality of sources and provides in three-dimensions a plurality of client stations representations, at least one server station representations, and a plurality of forms of data transmission representations for representing data transmission and communications between said plurality of client stations and said at least one server system using said video animation subsystem. The present disclosure includes forming operational characteristics representations associated with said plurality of client stations representations, said at least one server system representation, and said plurality of forms of data transmission representations using said video animation subsystem, thereby forming a dynamic, three-dimensional representation of the network comprising said operational characteristics, said plurality of client stations, said at least one server system, said plurality of forms of data transmission. Furthermore, the present disclosure interfaces said dynamic, three-dimensional representation of the network with a network performance analysis system for further analyzing perceived operational characteristics representations with reference to a plurality of network performance metrics associated with said network performance analysis system.

The presently disclosed subject matter presenting dynamic, three-dimensional representation of the network as a navigable three-dimensional space through which a user may travel to more closely analyze selected aspects of the network and simultaneously forming operational characteristics representations associated with said plurality of client stations representations, said at least one server system representation, and said plurality of forms of data transmission representations from a plurality of independent sources providing operational characteristics. Furthermore, the present disclosure includes generating auditory signals relating to said operational characteristics representations and correlating the speed of transmitting said data transmission within said network to a pitch of said auditory signal.

A further aspect of the present disclosure includes presenting said operational characteristics representations as a plurality of differing colors for said plurality of client stations representations, said at least one server system representation, and/or said plurality of forms of data transmission representations according to the network performance of said plurality of client stations, said at least one server system, and said plurality of forms of data communication. The present system correlates auditory signals relating to said operational characteristics representations with said plurality of differing colors.

The disclosed method and system visually demonstrate an alarm condition for said plurality of client stations representations, said at least one server system representation, and/or said plurality of forms of data transmission representations according to respectively reaching an alarm setpoint relating to said plurality of client stations, said at least one server system, and/or said plurality of forms of data transmission. The representations appear as smoking in the event of a respectively reaching a reduced operational status and as burning in the event of an even further reduced operational status. In addition, the disclosed system visually demonstrates the rate of transmitting said plurality of forms of data transmission, as well as visually demonstrating the failure of transmitting any one of said plurality of forms of data transmission.

A further aspect of the disclosed subject matter includes selectively providing a reduced subset of said plurality of client stations representations, said at least one server system representation, and/or said plurality of forms of data transmission representations using a filtering operation for said selected ones of said plurality of client stations, said at least one server system, and/or said plurality of forms of data transmission.

As seen above, the data network representation features and functions described herein for representing network performance characteristics from a plurality of sources and providing in three-dimensions a plurality of client stations representations associated with a predetermined data and communications network using a video animation subsystem may be implemented in various manners. For example, the present embodiments may be implemented in an application specific integrated circuit (ASIC), a microcontroller, a digital signal processor, or other electronic circuits designed to perform the functions described herein. Moreover, the process and features here described may be stored in magnetic, optical, or other recording media for reading and execution by such various signal and instruction processing systems. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method for representing network performance characteristics from a plurality of sources, comprising the steps of:
providing in three-dimensions a plurality of client stations representations associated with a predetermined data and communications network using a video animation subsystem;
providing in three-dimensions at least one server station representations associated with a predetermined data and communications network using said video animation subsystem;
providing a plurality of forms of data transmission representations for representing data transmission and communications between said plurality of client stations and said at least one server system using said video animation subsystem;
forming operational characteristics representations associated with said plurality of client stations representations, said at least one server system representation, and said plurality of forms of data transmission representations using said video animation subsystem, thereby forming a dynamic, three-dimensional representation of the network comprising said operational characteristics, said plurality of client stations, said at least one server system, said plurality of forms of data transmission;
interfacing said dynamic, three-dimensional representation of the network with a network performance analysis system for further analyzing perceived operational characteristics representations with reference to a plurality of network performance metrics associated with said network performance analysis system.

2. The method of claim 1, further comprising the step of presenting dynamic, three-dimensional representation of the network as a navigable three-dimensional space through which a user may travel to more closely analyze selected aspects of the network.

3. The method of claim 1, further comprising the step of simultaneously forming operational characteristics representations associated with said plurality of client stations representations, said at least one server system representation, and said plurality of forms of data transmission representations from a plurality of independent sources providing operational characteristics.

4. The method of claim 1, further comprising the step of generating auditory signals relating to said operational characteristics representations.

5. The method of claim 4, further comprising the step of correlating the speed of transmitting said data transmission within said network to a pitch of said auditory signal.

6. The method of claim 4, further comprising the step of presenting said operational characteristics representations as a plurality of differing colors for said plurality of client stations representations, said at least one server system representation, and/or said plurality of forms of data transmission representations according to the network performance of said plurality of client stations, said at least one server system, and said plurality of forms of data communication.

7. The method of claim 7, further comprising the step of correlating auditory signals relating to said operational characteristics representations with said plurality of differing colors.

8. The method of claim 1, further comprising the step of presenting said operational characteristics representations as a plurality of differing colors for said plurality of client stations representations, said at least one server system representation, and/or said plurality of forms of data transmission representations according to the network performance of said plurality of client stations, said at least one server system, and said plurality of forms of data communication.

9. The method of claim 1, further comprising the step of visually demonstrating an alarm condition for said plurality of client stations representations, said at least one server system representation, and/or said plurality of forms of data transmission representations according to respectively reaching an alarm setpoint relating to said plurality of client stations, said at least one server system, and/or said plurality of forms of data transmission.

10. The method of claim 1, further comprising the step of representing for said plurality of client stations representations, said at least one server system representation, and/or said plurality of forms of data transmission representations as smoking in the event of a respectively reaching a reduced operational status relating to said plurality of client stations, said at least one server system, and/or said plurality of forms of data transmission.

11. The method of claim 1, further comprising the step of representing said plurality of client stations representations, said at least one server system representation, and/or said plurality of forms of data transmission representations as burning in the event of a respectively reaching a reduced operational status relating to said plurality of client stations, said at least one server system, and/or said plurality of forms of data transmission.

12. The method of claim 1, further comprising the step of visually demonstrating the rate of transmitting said plurality of forms of data transmission.

13. The method of claim 1, further comprising the step of visually demonstrating the failure of transmitting any one of said plurality of forms of data transmission.

14. The method of claim 2, further comprising the step of selectively providing a reduced subset of said plurality of client stations representations, said at least one server system representation, and/or said plurality of forms of data transmission representations using a filtering operation for said selected ones of said plurality of client stations, said at least one server system, and/or said plurality of forms of data transmission.

15. A system for representing network performance characteristics from a plurality of sources, comprising:
a video animation subsystem for representing predetermined objects in three-dimensional animated space;
a plurality of client stations representations for representing in three-dimensional space a plurality of client stations associated with a predetermined data and communications network, said plurality of client stations representations formed using said video animation subsystem;
at least one server station representation for representing in three-dimensional space at least one server station associated with a predetermined data and communications network said at least one server station representation formed using said video animation subsystem;
a plurality of forms of data transmission representations for representing data transmission and communications between said plurality of client stations and said at least one server system using said video animation subsystem;
a plurality of operational characteristics representations associated with said plurality of client stations representations, said at least one server system representation, and said plurality of forms of data transmission representations using said video animation subsystem, thereby forming a dynamic, three-dimensional representation of the network comprising said operational characteristics, said plurality of client stations, said at least one server system, said plurality of forms of data transmission; and
interface means for interfacing said dynamic, three-dimensional representation of the network with a network performance analysis system for further analyzing perceived operational characteristics representations with reference to a plurality of network performance metrics associated with said network performance analysis system.

16. The system of claim 15, wherein said dynamic, three-dimensional representation of the network comprises a navigable three-dimensional space through which a user may travel to more closely analyze selected aspects of the network.

17. The system of claim 15, wherein said operational characteristics representations simultaneously associate said plurality of client stations representations, said at least one server system representation, and said plurality of forms of data transmission representations with a plurality of independent sources providing operational characteristics.

18. The system of claim 15, further comprising a plurality of auditory signals relating to said operational characteristics representations.

19. The system of claim 18, further comprising a speed representation for correlating the speed of transmitting said data transmission within said network to a pitch of said auditory signal.

20. The system of claim 18, wherein said operational characteristics representations represent a plurality of differing colors for said plurality of client stations representations, said at least one server system representation, and/or said plurality of forms of data transmission representations according to the network performance of said plurality of client stations, said at least one server system, and said plurality of forms of data communication.

21. The system of claim 20, wherein said auditory signals relate said operational characteristics representations with said plurality of differing colors.

22. The system of claim 18, wherein said operational characteristics representations appear as a plurality of differing colors for said plurality of client stations representations, said at least one server system representation, and/or said plurality of forms of data transmission representations according to the network performance of said plurality of client stations, said at least one server system, and said plurality of forms of data communication.

23. The system of claim 18, further comprising a visually demonstration of an alarm condition for said plurality of client stations representations, said at least one server system representation, and/or said plurality of forms of data transmission representations according to respectively reaching an alarm set point relating to said plurality of client stations, said at least one server system, and/or said plurality of forms of data transmission.

24. The system of claim 18, wherein said plurality of client stations representations, said at least one server system representation, and/or said plurality of forms of data transmission appear as smoking in the event of a respectively reaching a reduced operational status relating to said plurality of client stations, said at least one server system, and/or said plurality of forms of data transmission.

25. The system of claim 18, further comprising the step of representing for said plurality of client stations representations, said at least one server system representation, and/or said plurality of forms of data transmission representations as burning in the event of a respectively reaching a reduced operational status relating to said plurality of client stations, said at least one server system, and/or said plurality of forms of data transmission.

26. The system of claim 18, further comprising the step of visually demonstrating the rate of transmitting said plurality of forms of data transmission.

27. The system of claim 18, further comprising the step of visually demonstrating the failure of transmitting any one of said plurality of forms of data transmission.

28. The system of claim 19, further comprising the step of selectively providing a reduced subset of said plurality of client stations representations, said at least one server system representation, and/or said plurality of forms of data transmission representations using a filtering operation for said selected ones of said plurality of client stations, said at least one server system, and/or said plurality of forms of data transmission.

29. A computer usable medium having computer readable program code means embodied therein for representing network performance characteristics from a plurality of sources, the computer usable medium comprising:
computer readable program code means for providing in three-dimensions a plurality of client stations representations associated with a predetermined data and communications network using a video animation subsystem;
computer readable program code means for providing in three-dimensions at least one server station representations associated with a predetermined data and communications network using said video animation subsystem;
computer readable program code means for providing a plurality of forms of data transmission representations for representing data transmission and communications between said plurality of client stations and said at least one server system using said video animation subsystem;
computer readable program code means for forming operational characteristics representations associated with said plurality of client stations representations, said at least one server system representation, and said plurality of forms of data transmission representations using said video animation subsystem, thereby forming a dynamic, three-dimensional representation of the network comprising said operational characteristics, said plurality of client stations, said at least one server system, said plurality of forms of data transmission;
computer readable program code means for interfacing said dynamic, three-dimensional representation of the network with a network performance analysis system for further analyzing perceived operational characteristics representations with reference to a plurality of network performance metrics associated with said network performance analysis system.

30. The computer usable medium of claim 29, further comprising computer readable program code means for presenting dynamic, three-dimensional representation of the network as a navigable three-dimensional space through which a user may travel to more closely analyze selected aspects of the network.

31. The computer usable medium of claim 29, further comprising computer readable program code means for simultaneously forming operational characteristics representations associated with said plurality of client stations representations, said at least one server system representation, and said plurality of forms of data transmission representations from a plurality of independent sources providing operational characteristics.

32. The computer usable medium of claim 29, further comprising computer readable program code means for generating auditory signals relating to said operational characteristics representations.

33. The computer usable medium of claim 29, further comprising computer readable program code means for correlating the speed of transmitting said data transmission within said network to a pitch of said auditory signal.

34. The computer usable medium of claim 29, further comprising computer readable program code means for presenting said operational characteristics representations as a plurality of differing colors for said plurality of client stations representations, said at least one server system representation, and/or said plurality of forms of data transmission representations according to the network performance of said plurality of client stations, said at least one server system, and said plurality of forms of data communication.

35. The computer usable medium of claim 29, further comprising computer readable program code means for presenting said operational characteristics representations as a plurality of differing colors for said plurality of client stations representations, said at least one server system representation, and/or said plurality of forms of data transmission representations according to the network performance of said plurality of client stations, said at least one server system, and said plurality of forms of data communication.

36. The computer usable medium of claim 29, further comprising computer readable program code means for visually demonstrating an alarm condition for said plurality of client stations representations, said at least one server system representation, and/or said plurality of forms of data transmission representations according to respectively reaching an alarm setpoint relating to said plurality of client stations, said at least one server system, and/or said plurality of forms of data transmission.

37. The computer usable medium of claim 29, further comprising computer readable program code means for representing for said plurality of client stations representations, said at least one server system representation, and/or said plurality of forms of data transmission representations as smoking in the event of a respectively reaching a reduced operational status relating to said plurality of client stations, said at least one server system, and/or said plurality of forms of data transmission.

38. The computer usable medium of claim 29, further comprising computer readable program code means for representing said plurality of client stations representations, said at least one server system representation, and/or said plurality of forms of data transmission representations as burning in the event of a respectively reaching a reduced operational status relating to said plurality of client stations, said at least one server system, and/or said plurality of forms of data transmission.

39. The computer usable medium of claim 29, further comprising computer readable program code means for visually demonstrating the rate of transmitting said plurality of forms of data transmission.

40. The computer usable medium of claim 29, further comprising computer readable program code means for visually demonstrating the failure of transmitting any one of said plurality of forms of data transmission.
